(19) United States
(12) Patent Application Publication
(10) Pub. No.: US 2013/0075976 A1
(43) Pub. Date: Mar. 28, 2013

(54) COMPLIANT MOUNTING OF AN AXIAL FACE SEAL ASSEMBLY

(71) Applicants: Todd A. Davis, Tolland, CT (US); Douglas J. Howe, South Windsor, CT (US)

(72) Inventors: Todd A. Davis, Tolland, CT (US); Douglas J. Howe, South Windsor, CT (US)

(21) Appl. No.: 13/239,998

(22) Filed: Sep. 22, 2011

(51) Int. Cl. F02C 7/28; F16J 15/34

(52) U.S. Cl. 277/379; 277/306

(57) ABSTRACT

A axial face seal assembly includes first and second structures rotatable relative to one another about an axis. A carrier supports a seal that engages the second structure. The carrier is configured to move along the axis. First and second springs operatively are arranged between the first structure and the carrier. The first and second springs are configured to bias the carrier relative to the second structure respectively in first and second directions along the axis for providing a desired closing force on the second structure. A method of sealing a rotating structure includes biasing a seal toward a rotating sealing surface with a first spring to provide a desired axial closing force. The axial position of the seal relative to the rotating sealing surface is changed to an undesired axial closing force. The seal is biased with a second spring to achieve the desired axial closing force.

### BACKGROUND

This disclosure relates to mechanical face seals, and more particularly, to a mechanical face seal suitable for use with a gas turbine engine bearing compartment.

The seal assembly includes a carrier mounted on a guide assembly having multiple circumferentially arranged guide pins. The carrier slides axially along the guide pins and supports a carbon seal that engages the rotating sealing surface. A spring element is arranged between the carrier and a fixed structure, such as a housing, to bias the seal into engagement with the rotating sealing surface.

### SUMMARY

An axial face seal assembly includes first and second structures rotatable relative to one another about an axis. A carrier supports a seal that engages the second structure. The carrier is configured to move along the axis. First and second springs operatively are arranged between the first structure and the carrier. The first and second springs are configured to bias the carrier relative to the second structure respectively in first and second directions along the axis for providing a desired seal force on the second structure.

A method of sealing a rotating structure includes biasing a seal toward a rotating sealing surface with a first spring to provide a desired axial seal force. The axial position of the seal relative to the rotating sealing surface is changed to an undesired axial closing force. The seal is biased with a second spring to achieve the desired axial closing force.

### BRIEF DESCRIPTION OF THE DRAWINGS

The disclosure can be further understood by reference to the following detailed description when considered in connection with the accompanying drawings wherein:

FIG. 1 is a schematic view of an example gas turbine engine.

FIG. 2 is a schematic view of a bearing compartment.

FIG. 3 is a schematic view of an example seal assembly.

FIG. 4A is a schematic view of another example seal assembly in a first condition.

FIG. 4B is a partial schematic view of a portion of the bearing assembly illustrated in FIG. 4A in a second condition.

FIG. 5 is a schematic view of another example seal assembly.

Like reference numerals are used to illustrate like elements in the Figures.

### DETAILED DESCRIPTION

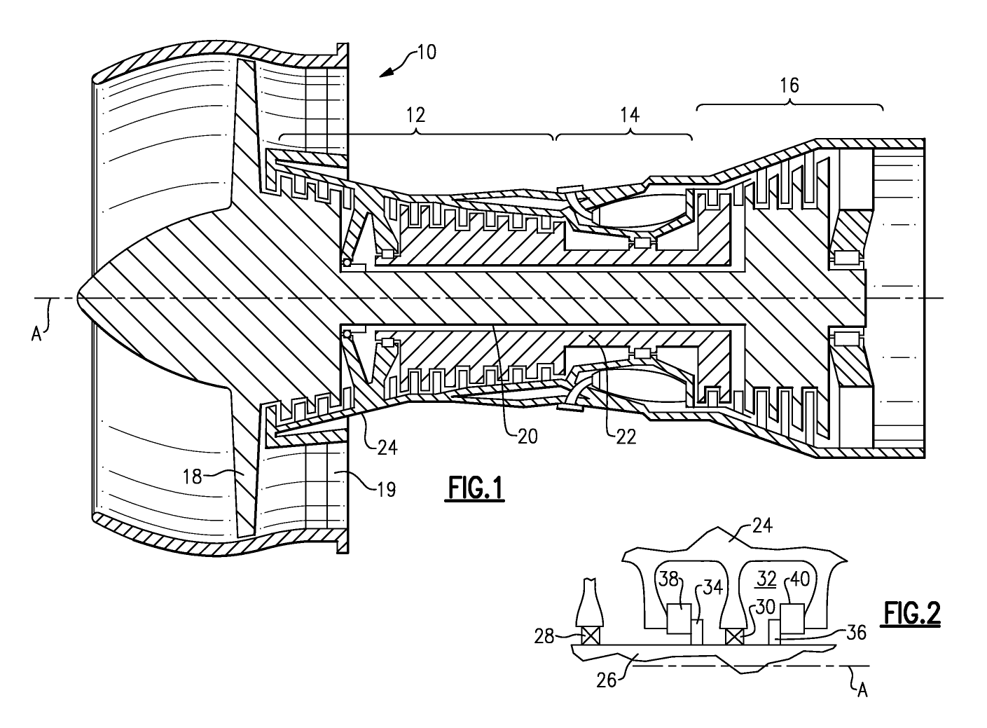

An example gas turbine engine 10 is schematically illustrated in FIG. 1. Although a high bypass engine is illustrated, it should be understood that the disclosure also relates to other types of gas turbine engines, such as turbo jets.

The gas turbine engine 10 includes a compressor section 12, a combustor section 14 and a turbine section 16, which are arranged within a housing 24. In the example illustrated, high pressure stages of the compressor section 12 and the turbine section 16 are mounted on a first shaft 20, which is rotatable about an axis A. Low pressure stages of the compressor section 12 and turbine section 16 are mounted on a second shaft 22 which is coaxial with the first shaft 20 and rotatable about the axis A. In the example illustrated, the first shaft 20 rotationally drives a fan 18 that provides flow through a bypass flow path 19. It should be understood that the configuration illustrated in FIG. 1 is exemplary only, and the disclosure may be used in other configurations.

The first and second shafts 20, 22 are supported for rotation within the housing 24. Typically, one or more bearing compartments are provided within the housing 24 to isolate lubrication fluid from other areas of the engine 10. The housing 24 is typically constructed of multiple components to facilitate assembly.

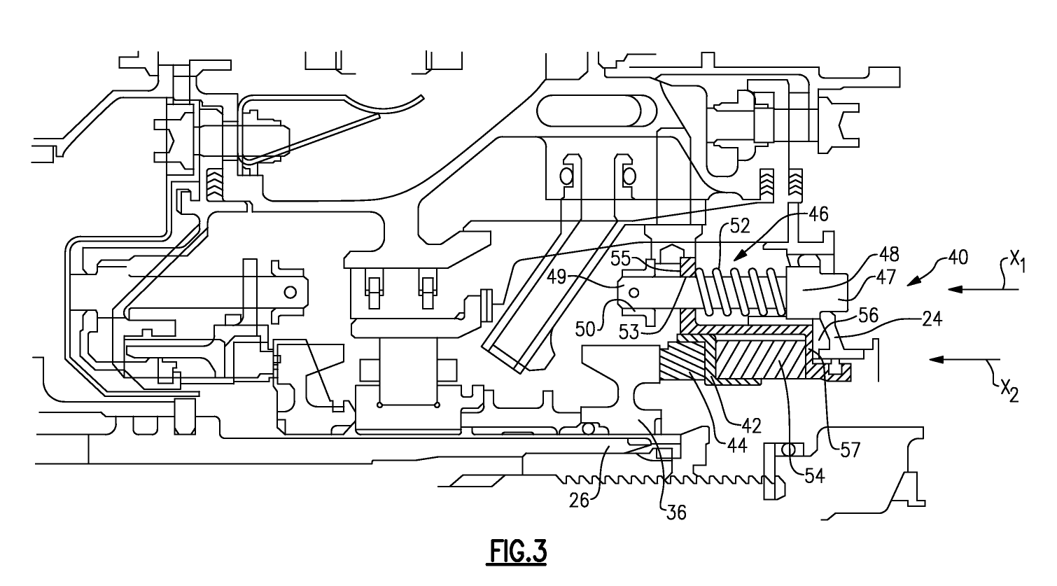

Referring to the schematic in FIG. 2, the housing 24 rotationally supports a shaft 26 for rotation with first and second bearings 28, 30. The first bearing 28, which is arranged at a front portion of the engine 10 in the example, is a ball bearing-type arrangement that permits very limited axial movement. The second bearing 30 is arranged rearward of the first bearing 28 and is disposed in a bearing compartment 32 that retains lubrication fluid within the compartment 32 to lubricate the second bearing 30. The second bearing 30 is a type which permits axial movement of the shaft 26 relative to the housing 24 due to thermal expansion and contraction that is typical during engine operation.

In the example, first and second seal plates 34, 36 are mounted on the shaft 26 and provide rotating sealing surfaces. First and second seal assemblies 38, 40 are supported by the housing 24 and respectively provide a seal between the housing 24 and the first and second seal plates 34, 36. Example seal assemblies 40, 140, 240 are illustrated in FIGS. 3-5. Too much closing force results in premature seal wear, while too little closing force results in inadequate sealing. The seal assemblies are configured to better accommodate axial displacement between the seal plate and the seal assemblies to maintain desired uniform closing forces throughout engine operation.

An example seal assembly 40 is illustrated in FIG. 3, which is configured to provide a desired closing force. A seal 44, such as a carbon seal, is mounted to a carrier 42. The seal plate 36 is supported on the shaft 26. A guide assembly 46 is supported on a structure, such as the housing 24, which is a stationary or fixed structure. The guide assembly 46 includes multiple circumferentially arranged guide pins 48 supported by the housing 24. An intermediate carrier 56 is slideably supported by the guide pins 48 for axial movement in a first direction X1, which is parallel to the rotational axis A.

The intermediate carrier 56 includes first and second flanges 55, 57. The first flange 55 includes an aperture 53 that slideably receives the guide pin 48. The guide pin 48 includes first and second spaced part ends 47, 49. The first end 47 is received by the housing 24. The second end 49 includes a retainer 50 that retains the intermediate carrier 56 on the guide pins 48 throughout operation.

A first spring 52 is arranged between the first flange 55 and a fixed structure, such as the guide pin 48 (illustrated) or other fixed structure, such as a housing 24. In the example, the first spring 52 is a coil spring disposed about the guide pin 48.

A second spring 54 is arranged between the carrier 42 and the intermediate carrier 56. In one example, the second spring 54 is an annular spring such as a bellows-type spring. The second spring 54 biases the carrier 42 and its mounted seal 44 in a second direction X2 that is parallel to the rotation axis A. In the example, the first and second springs, 52, 54 are in series with one another such that both springs operate to bias the seal 44 into engagement with the seal plate 36.

The seal assembly 40 provides the desired closing force with the second spring 54 during initial engine operation. As axial gapping between the components changes during engine operation, the desired closing force applied by the second spring 54 may decrease. However, the first spring 52 supplements the closing force provided by the second spring 54 to maintain the desired closing force.

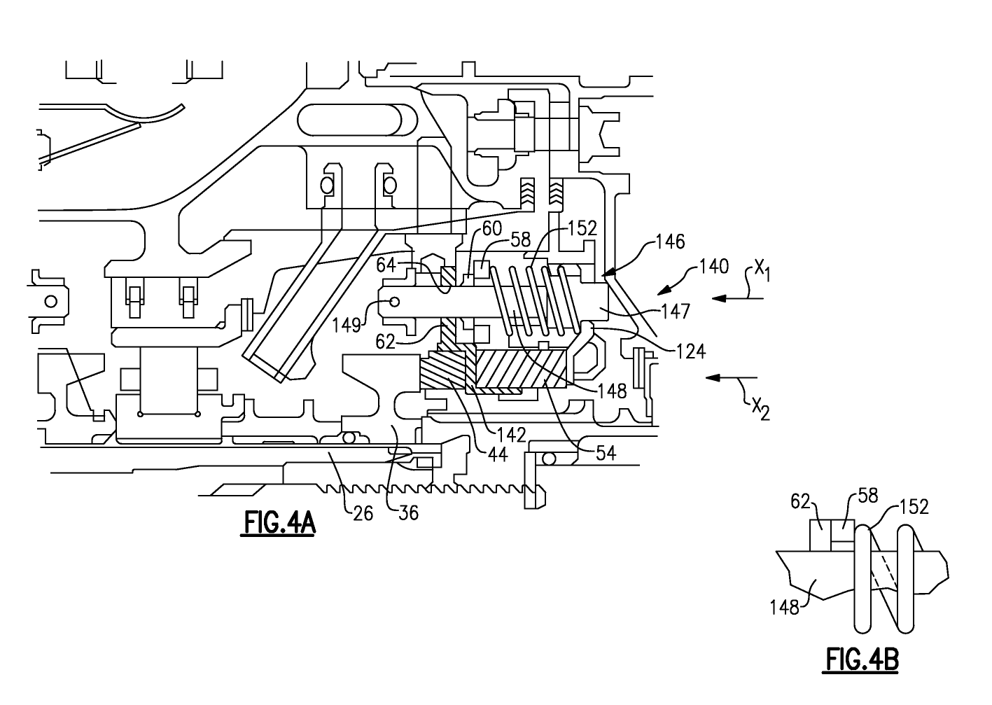

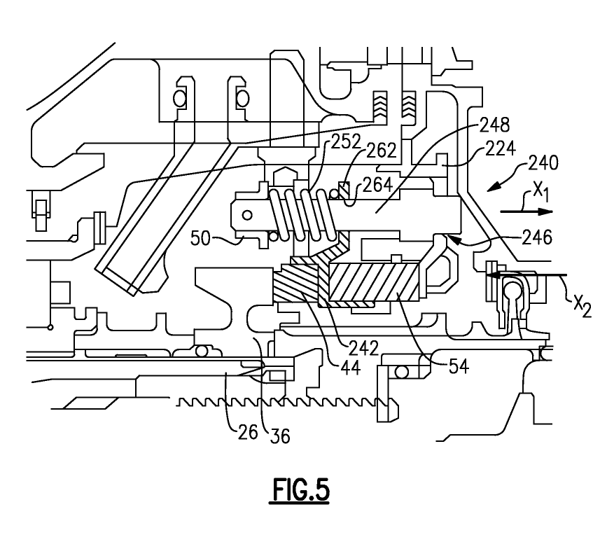

Referring to FIGS. 4A and 4B, another seal assembly 140 is illustrated. Similar to the embodiment illustrated in FIG. 3, the guide assembly 146 includes guide pins 148 having first and second opposing ends 147, 149. The first end 147 is mounted in the housing 124. The carrier 142 includes a flange 62 having an aperture 64 that slidably receives the guide pin 148. A stop 60 is provided on the guide pin 148. The first spring 150 is disposed on the guide pin 148 and is retained by a spring seat 58 that abuts the stop 60 to limit the travel of the first spring 152.

The first spring 152 provides a closing force in a first direction X1. The second spring 54 is arranged between the housing 124 and the carrier 142, such that the first and second springs 152, 54 are arranged in parallel with one another. The carrier 142 supports the seal 44, which engages the second plate 36 mounted on the shaft 26. The second spring 54 provides a closing force in a second direction X2, which is the same direction as the first direction X1.

The second spring 54 provides first and second conditions, respectively illustrated in FIGS. 4A and 4B. In the first condition, the first spring 152 just engages or is spaced from the carrier 142 such that little or no closing force from the first spring 152 is applied to the carrier 142. In this first condition, the second seal 54 provides the desired closing force. As the second seal plate 36 moves axially to the right, as illustrated in FIG. 4A, the flange 62 will move the spring seat 58 to the right, as illustrated in FIG. 4B, at which time the first spring 152 will urge the seal 44 back toward the second seal plate 36.

Another seal assembly 240 is illustrated in FIG. 5. In this arrangement, the first and second springs 252, 254, which are in series but oppose one another, have first and second directions X1, X2 that are opposite one another. The first spring 252 is arranged between the flange 262 and the retainer 50, which biases the carrier 242 away from the second seal plate 36. The second spring 54, which is arranged between the housing 224 and the carrier 242, urges the seal 44 into engagement with the second plate 36, which is mounted on the shaft 26. Thus, the first and second springs 252, 254 balance one another to maintain the desired closing force.

Although an example embodiment has been disclosed, a worker of ordinary skill in this art would recognize that certain modifications would come within the scope of the claims. For that reason, the following claims should be studied to determine their true scope and content.

What is claimed is:

1. An axial face seal assembly comprising:
first and second structures rotatable relative to one another about an axis;
a carrier supporting a seal that engages the second structure, the carrier configured to move along the axis; and
first and second springs operatively arranged between the first structure and the carrier, the first and second springs configured to bias the carrier relative to the second structure respectively in first and second directions along the axis for providing a desired closing force on the second structure.

2. The axial face seal assembly according to claim 1, wherein the first structure is a static housing, and the second structure is a rotating seal plate.

3. The axial face seal assembly according to claim 2, comprising a bearing compartment housing a bearing, the second structure disposed within the bearing compartment.

4. The axial face seal assembly according to claim 1, comprising a guide assembly mounted on the first structure, the guide assembly supporting the first spring.

5. The axial face seal assembly according to claim 4, wherein the guide assembly includes a guide pin, and the first spring is mounted coaxially with the guide pin.

6. The axial face seal assembly according to claim 5, comprising an intermediate carrier slidably supported by the guide pin, the second spring arranged between the carrier and the intermediate carrier, the first spring biasing the intermediate carrier toward the second structure.

7. The axial face seal assembly according to claim 6, wherein the first spring is arranged between the intermediate carrier and the first structure.

8. The axial face seal assembly according to claim 5, wherein the first spring operatively disengages and engages from the carrier respectively in first and second conditions.

9. The axial face seal assembly according to claim 8, wherein the guide assembly includes a stop, and the first spring engages a spring seat that engages the stop in the second condition and disengages the stop in the first condition.

10. The axial face seal assembly according to claim 5, wherein the first spring is arranged between guide pin retainer and the carrier to bias the carrier away from the second structure.

11. The axial face seal assembly according to claim 1, wherein the second spring is a bellows spring biasing the carrier towards the second structure.

12. The axial face seal assembly according to claim 1, wherein the first and second springs are arranged in series with one another.

13. The axial face seal assembly according to claim 1, wherein the first and second springs are arranged in parallel relative to one another.

14. The axial face seal assembly according to claim 1, wherein the first and second directions are opposite one another.

15. A method of sealing a rotating structure comprising:
biasing a seal toward a rotating sealing surface with a first spring to provide a desired axial closing force;
changing the axial position of the seal relative to the rotating sealing surface to an undesired axial closing force; and
biasing the seal with a second spring to achieve the desired axial closing force.
